(19) United States
(12) Patent Application Publication
(10) Pub. No.: US 2006/0114345 A1
(43) Pub. Date: Jun. 1, 2006

(54) Low power programmable reset pump for CMOS imagers

(76) Inventors: Jiangfeng Wu, Aliso Viejo, CA (US); Jiafu Luo, Irvine, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/000,527

(22) Filed: Dec. 1, 2004

(51) Int. Cl. H04N 5/335

(52) U.S. Cl. 348/308

(57) ABSTRACT

There is provided a circuit comprising a plurality of pixels arranged in rows and columns, a charge pump having a first input voltage and a second input voltage and having at least one output, at least one reset driver operatively connected to each row of the pixels, wherein the at least output of the charge pump provides a first reset voltage to at least one row of pixels at a first time and provides a second reset voltage to at least one row of other pixels at a second time. The charge pump may include a capacitor selectively connected to the first input voltage and the second input voltage, whereon the capacitor accumulates a boosted voltage.

### BACKGROUND OF THE INVENTION

1. Technical Field

The invention relates to semiconductor imaging devices and in particular to a silicon imaging device which can be fabricated using a standard CMOS process. Such devices are typically comprised of pixels arranged in rows and columns. The pixels provide an electrical output corresponding to of the incident light to which the pixels are exposed.

2. Background Art

A conventional CMOS imager pixel typically employs a phototransistor or photodiode as a light detecting element, and is usually operated as follows. First, the pixel photodiode is reset with a reset voltage. This removes electrons from the “charge well” or “pixel well” of the photodetector, thereby placing an electronic charge across the capacitance associated with the photodiode. Next, the reset voltage is removed and the photodiode exposed to illumination. The incoming light creates free electrons in the pixel well, causing the charge stored across the photodiode capacitance to decrease at a rate proportional to the incident illumination intensity. At the end of an exposure period, the change in diode capacitance charge is detected and the photodiode is reset. The difference between the reset voltage and the voltage corresponding to the final capacitance charge indicates the amount of light received by the photodiode.

For illustration purposes, FIG. 1 shows a typical three-transistor pixel circuit (100) that may be used in a CMOS imager. The pixel contains a photodiode (150), reset signal (120), select signal (160) and three transistors: for reset (130), source follower (140), and row access (170). The reset transistor (130) is used to reset the potential of the photodiode (150) before (or after) a charge integration. The MOS transistors each have a threshold voltage Vₜₕ. As a result, if the reset voltage level (which is applied to the gate of reset transistor (130)) is the same as the supply voltage V_{DD} (110), the reset transistor (130) is unable to bring the potential of the photodiode (150) up to the full supply voltage. Moreover, the body effect significantly increases the threshold voltage Vₜₕ for the reset transistor (130) and source follower transistor (140), because neither transistor has its source tied to ground. Accordingly, the effect of the threshold voltage drops across the three transistors may cause the maximum output voltage Vₒᵤₜ (180) to be less than 1V. This can have a negative effect on the dynamic range of the imaging device.

New imaging applications are required to work with reduced power supply voltages compared to those of previous generations. But the signal dynamic range of CMOS imagers decreases with the power supply voltage. As the supply voltage drops from 5V to 2V conventional pixels may suffer a loss in dynamic range. The fundamental limit on peak SNR, however, is set by physical well capacity. Well capacity, which determines the fundamental limit on the peak signal-to-noise ratio (SNR), decreases with technology scaling as pixel size and supply voltages are reduced. As a result, SNR decreases potentially to the point where even peak SNR is inadequate. For example, given the threshold drops in the illustrative circuit of FIG. 1, its dynamic range may become unacceptable as the supply voltage V_{DD} (110) is reduced to less than 2.7 V.

One previous solution to these problems was to fabricate the pixels with low-threshold transistors. This provided a modest increase in dynamic range, but at great cost. A low-threshold manufacturing process is complex and much more expensive.

An alternative solution, designed to address the problems associated with the threshold voltage drop across the reset transistor, was to use a charge pump circuit. A charge pump may be used to boost the reset voltage above V_{DD}, and thereby compensate for the threshhold voltage drop across the reset transistor. U.S. Pat. No. 6,140,630 issued to Rhodes discloses such a charge pump circuit, which uses a ring oscillator to drive two clamp circuits.

The Rhodes charge pump has several disadvantages. The charge pump circuit consumes a large amount of power and requires a large amount of real estate on a silicon chip. In addition, the ring oscillator is always “on” (continuously oscillating), which injects noise into the substrate. Moreover, since the charge pump is always on, the power consumed is high and the life time reliability is reduced. The more a circuit is used, the sooner it will wear out. Rhodes has a high duty cycle that reduces the useful life of the circuit. Additional noise is injected into the substrate when the clamp circuits turn on and off, which they do continuously.

The power that is dissipated by CMOS structures is composed of two factors: dynamic and static power dissipation. Dynamic power dissipation results from the active switching of the transistors' logic state. In contrast, static power dissipation occurs because of the current that leaks from the transistors while they're powered.

The main contributors to the dynamic power dissipation of CMOS structures are the applied voltage, operating frequency, and switching-structure capacitance. For static power dissipation, the main contributors are the applied voltage and the threshold voltage (Vt) of the used transistors. Of course, the silicon manufacturing process also influences on the overall power that is dissipated.

What is needed is a method and an apparatus for increasing or boosting a reset voltage for a pixel above a supply voltage to overcome transistor voltage drops associated with reset and source follower transistors inside a pixel. A charge pump is needed that is programmable, consumes minimal power, and has a low duty cycle. In addition, a charge pump is needed that does not inject noise during the signal readout and has low power consumption.

### BRIEF DESCRIPTION OF THE DRAWINGS

FIG. 1 is a schematic diagram illustrating a three-transistor pixel.

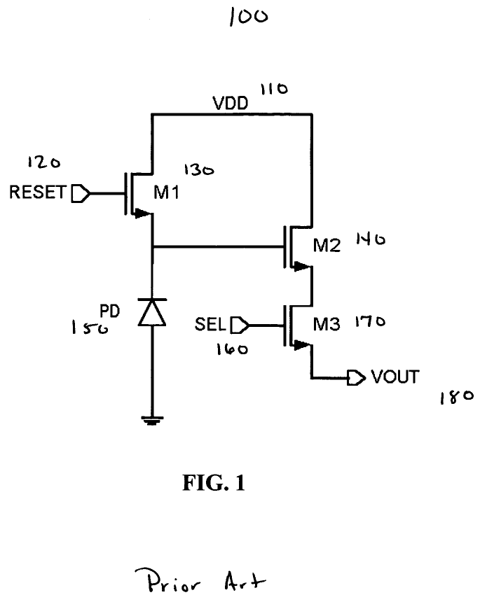

FIG. 2 is a diagram illustrating a prior art charge pump.

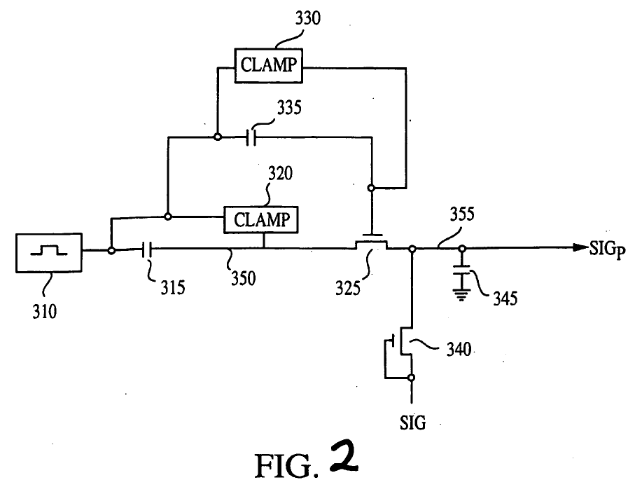

FIG. 3 is a diagram illustrating an embodiment of the present invention.

FIG. 4 is a diagram illustrating another embodiment of the present invention.

FIG. 5 is a diagram illustrating an embodiment of the switches in the charge pump of the present invention.

FIG. 6 is a diagram illustrating an embodiment of the reset driver used with the charge pump of the present invention.

FIG. 7 is a timing diagram for the charge pump of the present invention.

FIG. 8 is a diagram illustrating a waveform produced by the switches in the charge pump of the present invention.

### DETAILED DESCRIPTION OF THE INVENTION

Embodiments of the invention provide a method and an apparatus for increasing or boosting a pixel reset voltage above a supply voltage to overcome transistor voltage drops associated with the reset and source follower transistors inside a pixel. The present invention provides a charge pump to overdrive the reset transistor, that is, to apply a voltage to the gate of the reset transistor that is higher than the supply voltage. The exemplary charge pump supplies at least V_{DD}+V_{REF} volts to the gate of the reset transistor where V_{REF} is a voltage selected to compensate for the transistor threshold voltages.

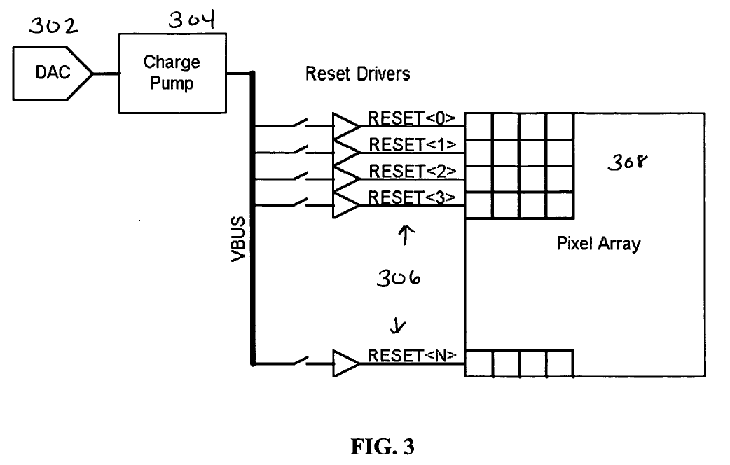

In an embodiment of the invention shown in FIG. 3, an on-chip charge pump (304) may generate a boosted voltage larger than the supply voltage from which it operates to provide a boosted reset voltage to each reset transistor gate located in selected pixel of an image array. Alternatively, the charge pump can be used to generate a voltage below a supply voltage (such as V_{SS}), which may be useful in embodiments (e.g. in which the n and p doping types are reversed). The voltage generated by the charge pump may be determined by an external reference, such as digital-to-analog converter (DAC) 302, thereby making the boosted voltage programmable.

The boosted voltage may then be distributed to an array of row-based high-voltage reset drivers (306), which supply the boosted reset voltage to the rows of pixels in an array (308). A pixel photodetector may be reset before integration with the boosted reset voltage provide by the charge pump. The boosted reset voltage removes electrons from the “charge well” or “pixel well” of the photodetector, thereby placing an electronic charge across the capacitance associated with the photodetector. The boosted reset voltage may be applied to the gate of a reset transistor, causing the transistor to turn on and remove electrons from the “charge well” or “pixel well” of the photodetector. The boosted reset voltage is preferably higher than the sum of the supply voltage and the threshold voltage of the reset transistor, thereby compensating for effects of the threshold voltage drop of the reset transistor (and a source follower transistor, if any). Applying a boosted reset voltage ensures that electrons are not left behind in the pixel well even when the previous received image signal level was very high.

This embodiment increases the dynamic operating range of each pixel, because the charge pump ensures that the maximum possible charge associated with the light incident on the pixel can be collected in the collection region beneath the photodetector.

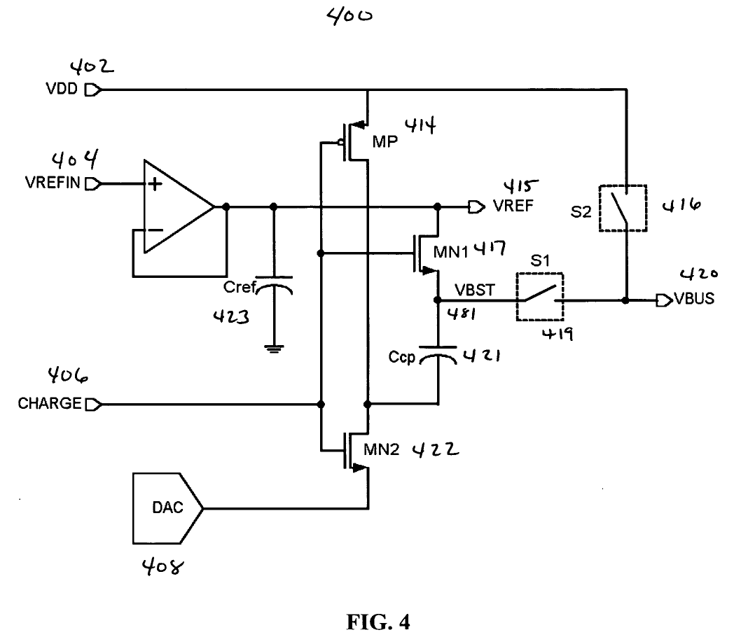

In an embodiment of the invention shown in FIG. 4, charge pump (400) is a bootstrap switch incorporating a capacitor Ccp (421). The capacitance is preferably large enough to supply a reset charge to at least two rows of pixels in an array. In other embodiments, a larger capacitor may be used to reset more than two rows of pixels in an array.

The charge pump (400) has two phases of operation: charging and pumping. During the charging phase, a charge switch is closed or turned on and a capacitor is charged to a reference voltage. During the pumping phase, the charge switch is turned off or opened and the lower-potential plate of the capacitor connected to the supply voltage. Because the capacitor maintains its stored charge, the voltage of the other plate of the capacitor is boosted above the supply voltage. The operation of an exemplary charge pump is now discussed in greater detail.

During the charging phase, the CHARGE signal (406) is asserted. The switches MN1 (417) and MN2 (422) are closed (on), and the switch MP (414) is open (off). When switch MN1 (417) is closed (off), one plate of capacitor C_{cp} (421) is connected to voltage V_{REF} (415). Similarly, when switch MN2 (422) is closed, the other plate of capacitor C_{cp} (421) is connected to the voltage output by DAC (408). Thus the capacitor C_{cp} (421) charges to the difference between the reference voltage and the DAC voltage, or V_{Ccp}≈V_{REF}−V_{DAC}. This charge may be stored in capacitor C_{cp} (421) until needed. The use of DAC (408) is preferable, as it allows the amount of charge stored in capacitor C_{cp} (and therefore the voltage) to be programmable, but it is optional. Alternatively, MN2 (422) could connect capacitor C_{cp} to supply voltage V_{SS} or another reference voltage (neither shown). An operational amplifier (421) and capacitor (423) may be used to provide a low output impedance for reference voltage source VREFIN (404).

During the pumping phase, the signal CHARGE (406) is brought low. This opens the switches MN1 (417) and MN2 (422) and closes the switch MP (414). This switch connects the bottom plate of the capacitor C_{cp} (421) to the supply voltage V_{DD} (402). Because capacitor C_{cp} (421) maintains its stored charge, the voltage at the top plate of capacitor C_{cp} (421) becomes V_{BST} (418), where V_{BST} is approximately V_{DD}+V_{REF}−V_{DAC}. For appropriate choices of V_{REF} and V_{DAC}, V_{BST} will be greater than the supply voltage V_{DD}. Note, once the capacitor is full, no current is flowing in the circuit. This is unlike the Rhodes charge pump where the oscillator continues to operate after the capacitor is charged.

The output of the exemplary charge pump circuit V_{BUS} (420) is controlled by switches S1 (419) and S2 (416). Switch S1 (419) controls whether the boosted voltage V_{BST} (418) is connected to or blocked from V_{BUS} (420). Switch S2 (416) controls whether the supply voltage V_{DD} (402) is connected to or blocked from V_{BUS} (420). The switches S1 (419) and S2 (416) should never be on at the same time. V_{BUS} is equal to V_{BST} if Switch S1 (419) is closed. V_{BUS} is equal to V_{DD} if Switch S2 (416) is closed. Although switches S1 (419) and S2 (416) provide flexibility in generating a reset voltage waveform, they are optional. For example, if the connection between V_{BUS} and V_{DD} is omitted, then the switches can be omitted as well.

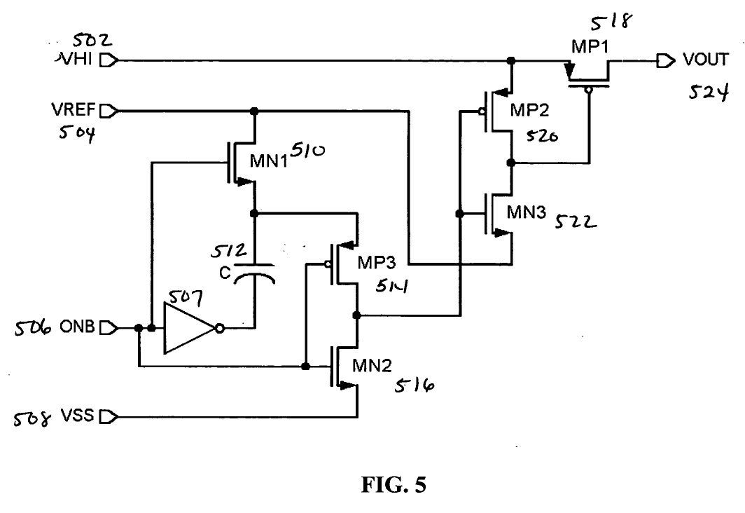

An exemplary circuit for the high-voltage switches S1 (419) and S2 (416) is depicted in FIG. 5. In order to properly switch the reset voltage between the high voltage V_{BST} and the supply voltage V_{DD}, the switches employ small charge pumps based on the same bootstrap switch principle as the charge pump (400). The input to switch (500) is V_{HI} (502), which, when used in the circuit of FIG. 4 for switch S1 (419), will be either V_{BST}. Similarly, the output is V_{OUT} (524), will be V_{BUS}. For switch S2 (419), the input to switch (500) V_{HI} will be V_{BUS}. Similarly, the output is V_{OUT} (524), will be V_{DD}. Signal ONB (506) controls whether the switch (500) is open or closed. When ONB (506) is high, transistors MN1 (510) and MN2 (516) are turned on and the output of inverter (507) is V_{SS} (508). The transistor MP3 (514) is turned off. The capacitor (512) will then charge until its voltage is approximately V_{REF}−V_{SS}. When MN2 (516) is on, MP2 (520) will be on and MN3 (522) will be off, causing MP1 (518) to be off (or open).

When ONB (506) brought low, MN1 (510) and MN2 (516) are turned off and the output of inverter (507) goes high (e.g. to V_{DD}), boosting the voltage of the top plate of capacitor (512) to approximately V_{REF}+V_{DD}−V_{SS}. This causes MP3 (514) to turn on and MN2 (516) to turn off, which in turn causes MN3 (522) to turn on, MP2 (520) to turn off, and MP1 (518) to turn on. As is apparent to one of ordinary skill in the art, the capacitor (512) is used to provide a boosted voltage to the gate of transistor MP2 (520) to ensure that it is turned off, given that its source is connected to V_{HI} (502), which may be boosted higher than the supply voltage. Also, the source and the body of the PMOS transistor MP1 (518) and MP2 (520) are connected to the highest voltage in the circuit to prevent the forming of a forward biased diode between its p-type drain and n-type body.

The boosted voltage may be distributed to the pixels by an array of compact row-based high-voltage drivers. Each row of the pixel array may have its own reset driver. It is preferable that the area of the driver circuit is small enough to be able to fit within the dimensions of a pixel, which is usually only a few microns. The reset driver may have a width in the range of approximately 10 μm-100 μm. A pixel size may be approximately 2.5 μm-7 μm.

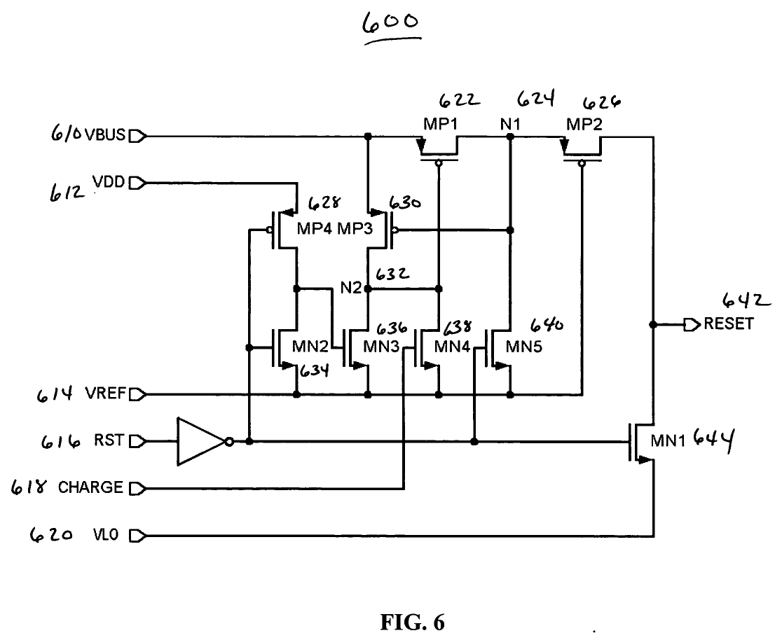

FIG. 6 shows a schematic of an exemplary row-based high-voltage reset driver. The core of the reset driver is a high-voltage switch based on an asymmetric self-triggered latch. The row-based high-voltage driver is deactivated during the CHARGE phase of the charge pump. Unlike the switch circuit shown in FIG. 5, the driver circuit does not require a capacitor to generate an internal high voltage, which allows the circuit area to be minimized.

The driver operates as follows. During the pumping phase, the bus voltage V_{BUS} will be V_{BST}, and the signal CHARGE 618 will be low. When a row is selected for reset, the signal RST (616) will be asserted (brought high). This turns on transistor MP4 (628) and ensures transistors MN1 (644), MN2 (634), and MN5 (640) are off. (MN4 (638) is off because the signal signal CHARGE (618) is not asserted.) When MP4 (628) is turned on, MN3 (636) turns on and pulls the voltage at node N2 (632) down to V_{REF} (614). This turns on MP1 (622), causing the voltage at node N1 (624) to rise to V_{BST}, turning off MP3 (630) and turning on MP2 (626), thereby passing passes V_{BST} from V_{BUS} (610) to the driver output RESET (642). Thus, when the row has been selected for reset, the boosted output voltage from the charge pump may be passed to the output of the reset driver, from which the RESET voltage is applied to the reset transistor gate in each pixel.

If a row is not selected for reset, the signal RST (616) will be de-asserted (brought low). This will turn on MN1 (644), MN2 (634), and MN5 (640), and turn off MP4 (637). MN5 (640) will pull the voltage at N1 (624) down to V_{REF} (614). This turns on MP3 (630), causing the voltage at N2 (632) to rise to V_{BST}, which turns off MP1 (622). Since MP2 (626) also turns off when the voltage at N1 (624) is pulled down to V_{REF} (614), MP1 (622) and MP2 (626) will isolate the driver output from V_{BUS} (610), which is instead pulled down to V_{LO} (620) by MN1 (644). V_{LO} (620) may be connected to V_{SS} (not shown).

The operation of driver (600) will be essentially the same whether the voltage on the input V_{BUS} is V_{DD} or the boosted voltage V_{BST}. During integration time, both MN4 and MN5 will be on, pulling down both N1 and N4 to V_{REF}. As a result, V_{BUS} needs to be pulled down to V_{REF} as well. The switch MN4 is need because most of time RST will be low, resulting N2 being a floating node if both N1 and V_{BUS} is V_{REF}. In alternative embodiment, a different design may be used to keep V_{BUS} at V_{DD} when circuit is not pumping, then MN4 can be omitted because N1 will be at V_{REF}, turning on MP3, which charges up N2 and turns off MP1.

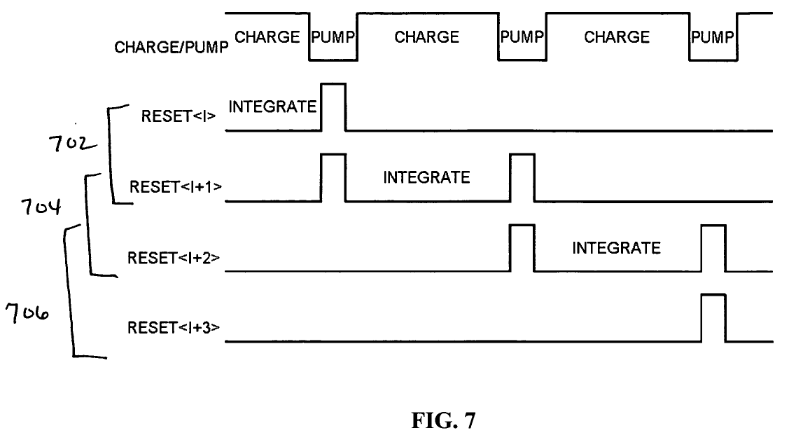

FIG. 7 shows an exemplary timing diagram of the charge pump and reset signals. Note, that all the switching occurs during the pump phase and not during the charge phase. Note also, that no switching occurs during the charge phase which avoids introducing noise during the integration period. While the exemplary charge pump is in the pumping phase, it is used to reset two rows of pixels at a time. In this example, RESET <I> and RESET <I+1> are reset during the first “pump” cycle (702); RESET <I+1> and RESET <I+2> are reset during the second “pump” cycle (704) and RESET <I+2> and RESET <I+3> are reset during the third “pump” cycle (706).

Because only two rows are reset at a time, all the other reset drivers are off and isolate their pixels from the charge pump's high-voltage output. This reduces the noise during readout. Because the charge pump only needs to provide enough charge to reset two rows of pixels instead of the whole array, a significant savings in power and area may be provided. The reset signals also have a very low duty cycle, usually lower than 1%. Therefore the voltage boost is only required for a very short period of time, which greatly increases the charge pump reliability.

Moreover, the charge pump does not require a continuous clock signal and has no switching activity during the CHARGE phase, which is when the signal readout occurs. This limits or eliminates any injection of supply and substrate noises during the signal readout. Due to the low duty cycle of the reset signal, the charge pump has no dynamic power dissipation most of the time, and the operational amplifier in the charge pump has low static current. This minimizes the total power consumption of the circuit.

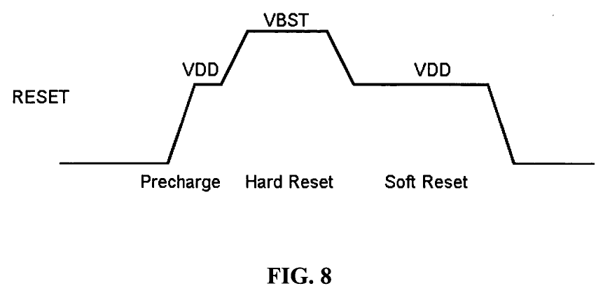

By alternatively turning on S1 (419) and S2 (416) during the reset cycle, complex reset sequences may be implemented. FIG. 8 illustrates one possible waveform of the RESET signal. For example, by alternatively turning on S1 (419) and S2 (416) in the charge pump, a sequence of precharge, hard reset and soft reset, may be realized. The precharge removes all history-dependent effects of the photodiodes and improves the signal dynamic range. The hard reset followed by soft reset scheme reduces the pixel reset noise while eliminating image lag. Completing the hard reset during the reset period reduces noise injected during the integration period. In other words, because the high-voltage only switch on/off during the reset period, any noise associated with the switching will not affect the image integration period or the read out. This avoids injecting noise from the charge pump during image integration, which is an advantage over the prior reset solutions. Other switching schemes may also be employed, including switching straight to V_{BST} if a large enough capacitor is used.

The flexibility offered by this reset pump circuit enables more complex reset schemes to be implemented than heretofore allowed in the prior art. Waveform shaping capability may be provided to allow the reset voltage to switch between the supply voltage and the higher boosted voltage for complex hard-soft reset schemes.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. The description herein is largely based on standard pixel sensor architecture, merely by way of example. Those skilled in the art will appreciate that aspects of the description may also be applied to other image sensors.

Accordingly, the above description and accompanying drawings are illustrative only of preferred embodiments which can achieve the features and advantages of the present invention. It is not intended that the invention be limited to the embodiments shown and described in detail herein. The invention is limited only by the scope of the following claims. While the invention has been described in detail by specific reference to preferred embodiments, it is understood that variations and modifications may be made without departing from the true spirit and scope of the invention.

We claim:

1. A pixel circuit comprising:
a plurality of pixels arranged in rows and columns,
a charge pump having a first input voltage and a second input voltage and having at least one output;
at least one reset driver operatively connected to each row of said pixels;
wherein said at least one output of said charge pump provides a first reset voltage to at least one row of pixels at a first time and provides a second reset voltage to at least one row other of pixels at a second time.

2. A pixel circuit according to claim 1, wherein said charge pump further comprises:
a capacitor selectively connected to said first input voltage and said second input voltage, wherein said capacitor accumulates a boosted voltage.

3. A pixel circuit according to claim 1, wherein said output of the charge pump may be selected to be approximately equal to said first input voltage plus said second input voltage.

4. A pixel circuit according to claim 1, wherein said output of the charge pump may be selected to be approximately equal to said first input voltage.

5. A pixel circuit according to claim 1, wherein said charge pump output is coupled to a first group of at least two rows of pixels at a first time and coupled to a second group of at least two rows of pixels at a second time.

6. A pixel circuit according to claim 5, wherein said charge pump output resets said first group of at least two rows of pixels at said first time and said second group of at least two rows of pixels at a second time.

7. A pixel circuit according to claim 2, wherein said charge pump further comprises a first switch for connecting said first voltage to a reset transistor gate in a pixel and a second switch for connecting said boosted voltage to said reset transistor gate in a pixel.

8. A pixel circuit according to claim 2, wherein said charge pump further comprises a first transistor having an input coupled to said first input voltage and an output coupled to said capacitor.

9. A pixel circuit according to claim 8, wherein said charge pump further comprises a second transistor having an input coupled to said second input voltage and an output coupled to said capacitor.

10. A pixel circuit according to claim 1, wherein said output of the charge pump is programmable.

11. A pixel circuit according to claim 10, further comprising a digital-to-analog converter having an output, wherein said charge pump has a third input voltage, which is provided by the output of said digital-to-analog converter.

12. A pixel circuit according to claim 2, wherein said capacitor is parallel plate capacitor.

13. A pixel circuit according to claim 2, wherein said capacitor is a gate of a MOS transistor.

14. A pixel circuit according to claim 1, wherein said reset driver is smaller than a pixel's width or height.

15. A pixel circuit according to claim 1, wherein said reset driver is a few microns in width or height.

16. An image circuit comprising:
a plurality of pixels arranged in rows and columns;
a charge pump circuit having a first input voltage (V_{DD}) and a second input voltage (V_{REF}) having at least one output;
wherein in a first state, a first group of pixels are reset by said charge pump circuit at a first time;
wherein in a second state, a second group of pixels are isolated from said first group of pixels at said first time;
wherein in a third state, a third group of pixels are reset by said charge pump circuit at a second time;
wherein said first group of pixels and said second group of pixels are isolated from said third group of pixels at said second time.

17. A method for resetting a pixel comprising the steps of:
providing a plurality of pixels arranged in rows and columns,
providing a charge pump having a first input voltage (V_{DD}) and a second input voltage (V_{REF}) and having at least one output;
providing at least one reset driver operatively connected to each row of said pixels;
providing a first reset voltage to at least one row of pixels at a first time and and a second reset voltage to another row of pixels at a second time.

18. A method for resetting a pixel according to claim 17, further comprising the step of selecting the output of the charge pump to be approximately equal to said first input voltage plus said second input voltage. (V_{BST})

19. A method for resetting a pixel according to claim 17, further comprising the step of selecting the output of the charge pump to be approximately equal to said first input voltage. (V_{DD})

20. A method for resetting a pixel according to claim 17, further comprising the step of coupling said charge pump output to at least one row of pixels at a first time and coupling said charge pump output to a second row of pixels at a second time.
